(19) United States
(12) Patent Application Publication
(10) Pub. No.: US 2023/0201956 A1
(43) Pub. Date: Jun. 29, 2023

(54) METHOD FOR ANALYZING A LASER MACHINING PROCESS, SYSTEM FOR ANALYZING A LASER MACHINING PROCESS, AND LASER MACHINING SYSTEM COMPRISING SUCH A SYSTEM

(71) Applicant: PRECITEC GMBH & CO. KG, Gaggenau (DE)

(72) Inventors: Joachim Schwarz, Kleinandelfingen (CH); Martin Krause, Graben-Neudorf (DE); Fabian Mack, Karlsruhe (DE)

(21) Appl. No.: 17/923,414

(22) PCT Filed: May 4, 2021
(86) PCT No.: PCT/EP2021/061724

§ 371 Date: Jan. 23, 2023

(30) Foreign Application Priority Data
May 5, 2020 (DE) 10 2020 112 116.4

(51) Int. Cl. B23K 26/03; G05B 19/406; G06N 3/08

(52) U.S. Cl. CPC B23K 26/032; G05B 19/406; G06N 3/08; G05B 2219/45165

(57) ABSTRACT

A method for analyzing a laser machining process for machining workpieces includes the steps of acquiring at least one sensor data set for the laser machining process and determining a value of at least one physical property of a machining result of the laser machining process based on the at least one sensor data set using a transfer function. The transfer function is formed by a trained neural network. A system for analyzing a laser machining process and a laser machining system including such a system are also disclosed.

### CROSS-REFERENCE TO RELATED APPLICATIONS

This application is the U.S. National Stage of PCT/EP2021/061724 filed on May 4, 2021, which claims priority to German Patent Application 102020112116.4 filed on May 5, 2020, the entire content of both are incorporated herein by reference in their entirety.

### FIELD OF THE INVENTION

The present invention relates to a method for analyzing a laser machining process on a workpiece, in particular on a metal workpiece, a system for analyzing a laser machining process and a laser machining system for machining a workpiece using a laser beam with such a system.

### BACKGROUND OF THE INVENTION

In a laser machining system for machining a workpiece using a laser beam, the laser beam emerging from a laser light source or from one end of a laser optical fiber is focused or collimated onto the workpiece to be machined by means of beam guidance and focusing optics in order to locally heat the workpiece to melting temperature. Machining may comprise, for example, joining, i.e. permanently connecting workpieces, in particular laser welding or laser soldering and laser cutting. In particular when laser welding or soldering a workpiece, it is important to monitor the welding or soldering process and to assess the quality of the machining result, i.e. a joint created between the workpieces, which is formed by a welded or soldered seam, in order to ensure machining quality. Current solutions for monitoring laser machining processes and assessing quality in laser welding usually include so-called in- and post-process monitoring and corresponding monitoring systems. In-process monitoring is also used to perform open-loop and closed loop control of the laser machining process.

For this purpose, for example during laser welding, the intensity of electromagnetic radiation at different wavelengths, which is emitted from an interaction zone between the laser beam and the workpiece, in particular plasma radiation, temperature radiation or laser radiation reflected or backscattered from a surface of the workpiece, is acquired and analyzed by means of data processing. For the analysis, the acquired data, for example corresponding intensity curves, are compared with specified reference curves or envelope curves. Based on predefined error criteria, an error is output by the monitoring system. Criteria may be, for example, the integral of the curves above the envelope curves or falling below or exceeding the envelope curves.

Furthermore, an image sensor may capture an image signal of a melt pool during the laser machining process. By means of image processing, geometric features of the melt pool, for example a geometry of the melt pool, in particular the shape, size and position of the melt pool, may be recognized and included in the monitoring. An error may also be output in the event of deviations from specified geometries.

Based on detected errors, the weld joint may be classified as “good” (i.e. the joined workpieces are suitable for further processing or sale) or as “poor” (i.e. the workpieces are rejected). In addition, welds may be divided into error classes. In the case of overlap welds, for example, there are the classes “missing connection”, “gap too large” or “hole” or “penetration”. Furthermore, the closed-loop control of the process can be influenced during the ongoing laser machining process.

For laser cutting, the roughness of the cutting edge, the burr height, the perpendicularity of the cutting edges and the steepness of the cutting front are features that provide information about the quality of the laser machining process. These features are typically determined or measured after the process. In serial systems, the detection of a cut break is not carried out during the machining process. The allowable quality is determined by measuring these features.

In conventional monitoring systems, the analysis of the data obtained from the laser machining process is complex since the data machining parameters and the error criteria depend on many factors and also have to be adjusted when the welding process changes. The parameters are therefore usually defined and set by experts. The experience of the experts is therefore decisive for reliable monitoring. Due to the complexity, the acquired data is typically analyzed independently. Monitoring taking into account all data is not carried out or a fusion of the information included in the data is only carried out at the end of the processing chain. Due to the complexity, the performance of such monitoring systems is also lacking.

The applications DE 10 2018 129 441.7 and DE 10 2018 129 425.5 describe the monitoring of laser machining processes using deep convolutional neural networks. This may increase the performance and reliability of the classification.

Due to the ever-increasing complexity of the applications of laser machining processes, more precise mappings and heuristics are required for the assessment of the process or a machining result. The classification into two or just a few classes does not allow, for example, for the cause of a machining error to be determined. It is not possible to draw conclusions about one or more physical variables or properties that describe the process or the machining result.

However, the weld seam must meet specified criteria. In particular, the weld seam must have a specified strength, in particular a tensile, compressive or shear strength. However, it is not possible to quantify the value of a physical property, for example a strength, a welding depth or a conductivity, by classifying the weld seam or the weld joint as described above. A conventional monitoring system can therefore only provide a classification of the machining result, but no physical measurement value or a value for a physical property of the machining result in physical units which allows a quantitative statement.

For a laser cut, the cut material must also meet criteria in the form of physical measurement values. The roughness of the cut edges and the burr height may be measured in µm, for example, while the perpendicularity of the cut edge is measured in degrees.

Therefore, in order to determine a value of a physical property of a machining result, a measurement must be performed after the laser machining. In order to determine this physical property of the weld, the weld or the welded workpieces must be subjected to a material test. For example, the welded workpieces are subjected to a tensile test to determine the tensile force in Newton at which the weld breaks. This value is defined as the tensile strength of the weld. When welding electrical contacts, the conductivity of the weld seam may be determined in Siemens. However, this measurement for material testing usually leads to the destruction of the workpieces and therefore cannot be carried out for all workpieces.

### SUMMARY OF THE INVENTION

It is an object of the present invention to provide a method with which the value of a physical property of a laser machining process or a machining result of a laser machining process, in particular a welding, soldering or cutting process, can be determined non-destructively without a measurement of the value having to be performed.

It is also an object of the present invention to specify a method to simplify or automate the determination of a value of a physical property of a laser machining process or a machining result of a laser machining process, in particular a welding, soldering or cutting process.

These objects are achieved by the subject matter disclosed herein. Advantageous embodiments and further developments are also disclosed.

According to a first aspect of the present disclosure, a method for analyzing a laser machining process for machining workpieces by means of a laser beam is provided, the method comprising the steps of: acquiring at least one sensor data set for the laser machining process; and quantifying or determining a value of at least one physical property of a machining result of the laser machining process based on the at least one sensor data set using a transfer function, the transfer function being formed by a trained neural network.

The laser machining process may comprise joining or connecting workpieces. The laser machining process may be or comprise a laser cutting process, a laser welding process or a laser soldering process. The machining result of the laser machining process may include the cut, joined or connected workpieces, i.e. the welded or soldered or cut workpieces. In particular, the machining result may refer to a welded j oint or soldered j oint between the joined workpieces in this case. The welded joint or soldered joint may be formed by a weld seam. In other words, the machining result may refer to the weld seam or soldered seam in this case. The machining result may also refer to a part or area of the welded joint or the weld seam. There may be a gap between the workpieces to be joined by the laser machining process, said gap affecting the result of the weld. The gap may refer to the space between two facing surfaces of the workpieces to be joined in the case of a butt weld or the space between the workpieces to be joined in the case of a lap weld. A distance between the facing surfaces of the joined workpieces may be referred to as a gap size. Too large a gap may represent a machining error of the laser machining process. In the case of a butt weld, the gap is determined in the pre-process, i.e. before the weld, in the case of a lap weld, the gap is determined using the clamping technique.

The machining result of the laser machining process may also comprise an intermediate result of the laser machining process, i.e. a feature that is (also or only) present when the laser machining process is being performed. In particular, the machining result may comprise a vapor capillary, also known as a “keyhole”, and/or a melt pool. A keyhole depth may be defined here as a distance between a bottom of the vapor capillary and the surface of the workpiece onto which the laser beam is radiated. The welding depth may be deduced from the keyhole depth.

The value of the physical property of the machining result may correspond to a value predicted or estimated for a measurement of the physical property of the machining result. In other words, determining the value of the physical property may be viewed as predicting or estimating a measurement of the physical property. This prediction or estimate of the measurement of the physical property may be a substitute for an actual measurement, i.e. without having to perform a measurement of the value. The determination of the value of the physical property of the machining result based on the sensor data set using a transfer function may therefore be used to predict or estimate a measurement value of the physical property of the machining result.

The at least one physical property of the machining result may include at least one of the following: strength, in particular tensile, compressive and/or shear strength, of a welded or soldered joint produced by the laser machining process, electrical conductivity of a welded or soldered joint produced by the laser machining process, a keyhole depth, a welding depth in a workpiece, a gap size between two workpieces joined by the laser machining process, a roughness of a cut edge of a workpiece cut by the laser machining process, a burr or a burr height of a cut edge of a workpiece cut by the laser machining process, a steepness of the cutting front and a perpendicularity of a cut edge of a workpiece cut by the laser machining process. When the keyhole depth or the steepness of the cutting front is determined or predicted using the method according to the invention, separate measuring devices, for example optical coherence tomographs, may be omitted in a laser machining system for carrying out the laser machining process. Determining a compressive strength value, on the other hand, is particularly relevant for butt-joined workpieces. The machining result during laser cutting may be described by the physical properties such as the roughness of the cut edges or the burr or the burr height of the cut edges or the perpendicularity of the cut edges.

The value of the physical property may be determined in a physical unit, e.g. in an “SI unit” (International System of Units). For example, strength in Newton (N) or Newton per area (N/m²), the welding depth in µm, the gap size in µm and the electrical conductivity in Siemens (S) may be determined. The roughness of a cut edge may be determined in the unit µm, for example.

The invention is therefore based on the idea of using a neural network to specify a value for a physical property of the machining result, i.e. to quantify the physical property, with the neural network using, as the input data set, at least one sensor data set, preferably raw data, acquired for the laser machining process. Using the method according to the invention, it is therefore possible to determine the value of the physical property of the machining result of the laser machining process in a non-destructive manner without performing a measurement of the value on the machining result. By means of the method according to the invention, a relationship between the sensor data acquired for the laser machining process and the physical property of the machining result may be specified or determined quantitatively, for example by regression. The method according to the invention thus allows a value of a physical property to be assigned to the machining result. The physical property may be a quality feature of the machining result, which may be specified, for example, by a standard or norm, e.g. relating to a material condition. Accordingly, a quality of the machining result, such as welded or soldered seams and cut edges, may be quantified or quantitatively described and evaluated based on the determined value of the physical property in order to specify a finely granular evaluation metric for analyzing the welded or soldered seams and cut edges and the corresponding laser machining processes.

According to the invention, physical quantities or properties that serve as interpretable quality features for assessing the machining quality are thus predicted by the transfer function of the trained neural network. In contrast to a simple classification of the machining result, the input data sets of the neural network are not only assigned to a class, for example “good” and “bad”, but to an absolute value of a physical property of the machining result. The method according to the invention thus allows, as an extension to the classification with a few classes, a regression to values, preferably physical measurement values, for the physical property. In the inference, the sensor data sets acquired for the laser machining process may be mapped directly to the regression result, i.e. to the value of the physical property, using the transfer function.

The at least one sensor data set may include sensor data based on a measurement of process radiation from the laser machining process, preferably at a specific wavelength or in a specific wavelength range. The acquisition of the sensor data set, for example the measurement of process radiation of the laser machining process, may be performed in a time-resolved manner and/or over a predetermined period of time. A sensor data set may therefore also be referred to as a “time data series”. The process radiation may include electromagnetic radiation emitted or reflected during the performance of the laser machining process from an interaction zone between the laser beam and a workpiece, also referred to as “process area” or “machining area”. The process radiation may include thermal radiation, plasma radiation, and laser radiation reflected and/or backscattered by the workpiece. The process radiation may also be measured in a spatially resolved and/or frequency resolved manner.

The at least one sensor data set may include sensor data based on a measurement of a process parameter of the laser machining process, for example a focus position of the laser beam, a focus diameter of the laser beam, a position of the laser machining head of a laser machining system performing the laser machining, or the like.

The measurement of process radiation may include a measurement of the radiation intensity of the process radiation. For this purpose, the radiation intensity may be measured for a predetermined period of time in at least one predetermined wavelength range and/or at at least one predetermined wavelength. A sensor data set may be recorded for each wavelength range or for each wavelength in which or at which the radiation intensity is measured. Accordingly, the sensor data of the radiation intensity measured over the predetermined period of time form a sensor data set in a wavelength range or at a wavelength. The radiation intensity may also be measured in a spatially resolved and/or frequency resolved manner.

Measuring the process radiation or the radiation intensity of a radiation emitted or reflected by a surface of the workpiece may include capturing an image of the surface of the workpiece. In other words, a sensor data set may include at least one image of the surface or a section of the surface of the workpiece. The section of the surface may include the machining area. The image may be a gray scale image. The image may include brightness and/or color information.

The value of the physical property may also be determined based on at least two sensor data sets. For example, the value of at least one physical property may be determined based on at least two sensor data sets that have been acquired by different sensors for the same period of time. The sensor data sets may each contain sensor data from process radiation in different wavelength ranges and/or at different wavelengths. Alternatively, a first sensor data set may be based on the measurement of process radiation, while a second sensor data set may be based on the measurement of at least one process parameter. By simultaneously considering a plurality of sensor data sets, different variables may be mapped. In addition, the machining result may be determined more reliably and quickly, in particular if end-to-end processing without pre-processing is used. As a result, the laser machining process can be monitored more reliably and accurately.

The at least one sensor data set may be acquired during and/or after the performance of the laser machining process. The value of the physical property may be determined while performing the laser machining process or after the laser machining process has been completed. Accordingly, the method according to the invention may be configured as an in-process or as a post-process method. The value of the physical property may be used to control the laser machining process, particularly when the value of the physical property is determined while performing the laser machining process. For example, the laser machining process may be controlled such that a difference between the determined value and a target value of the physical property of the machining result or a subsequent machining result is reduced. When the physical property is the welding depth in a workpiece and the determined value of the welding depth deviates from a target value of the welding depth, the laser machining process may be adjusted for a subsequent laser machining process such that a difference between the determined value of the welding depth and a current target value decreases. A closed-loop control of the laser machining process may include an adjustment of a focus position, a focus diameter of the laser beam, a laser power and/or a distance of a laser machining head.

The method according to the invention may be carried out continuously and/or repeatedly while the laser machining process is being performed. In other words, the at least one sensor data set may be acquired continuously and/or repeatedly and the value of the at least one physical property may be determined. The at least one physical property may be determined in real time.

The value of the physical property may further be determined based on at least one control data set of the laser machining process. The control data set may include control data. The control data may be specified by a higher-level control unit for controlling the laser machining process. The control data may include target values for process parameters. The control data may include data of at least one of the following: an output power of a laser, a focus position of the laser beam, a focus diameter of the laser beam, a position of the laser machining head of a laser machining system carrying out the laser machining, a machining speed, a path signal, a workpiece material and/or a workpiece thickness. The path signal may be a control signal from the laser machining system, which controls a movement of the laser machining head relative to the workpiece. The control data mentioned above may be acquired during the laser machining process and be provided in real time as a control data set. The control data set may include time-resolved or time-dependent control data and/or time-independent control data for a predetermined period of time.

It is advantageous when the data contained in different data sets, i.e. sensor data sets and/or control data sets, match. This may mean that the data contained in the different data sets were acquired or recorded during the same period. Furthermore, this may mean that, for predetermined points in time within a predetermined period of time, data are present in each of the acquired data sets. For this purpose, the sensor data and/or the control data may be acquired or recorded with the same sampling frequency. Alternatively, sensor data and/or the control data may be interpolated, or sensor data and/or control data may be discarded.

The transfer function is formed by a learned or trained neural network. The neural network may be trained by error feedback or backpropagation. The neural network may be a deep neural network, e.g. a deep convolutional neural network or convolutional network. The convolutional network may have at least one so-called “fully connected” layer.

The at least one sensor data set may serve as an input data set for the trained neural network. A plurality of acquired or recorded data sets may be combined to form an input tensor for the neural network. Alternatively, each acquired data set may form a separate input tensor. In this case, the neural network may include individual networks for the various acquired data sets, said networks being coupled via at least one common output layer. In particular, the trained neural network may be configured to map the input tensors formed from the various recorded data sets to a common output tensor using the transfer function.

The trained neural network or the transfer function may output the value of the at least one physical property as an output tensor. The neural network or the transfer function may also determine values of a plurality of physical properties simultaneously and output them as an output tensor. By simultaneously quantifying a plurality of physical properties of the machining result, the laser machining process may be monitored more reliably and accurately.

The trained neural network may be configured for transfer learning. The transfer learning may be based on at least one training data set. The at least one training data set may include at least one training sensor data set of the changed laser machining process and at least one corresponding predetermined value of the at least one physical property of the machining result. The predetermined value of the at least one physical property may have been determined by direct measurement on the machined workpiece. The at least one training data set may further include a training control data set of the changed laser machining process. A plurality of training data sets may be used to adjust or train the neural network.

As a result, the neural network forming the transfer function may be adapted to a changed situation or a changed laser machining process. The changed situation may be, for example, that the workpieces to be machined have different materials, degrees of contamination and/or thicknesses, or that the parameters of the laser machining are changed. In transfer learning, the training data sets used for training or teaching the neural network may be supplemented with new examples. The use of a trained neural network configured for transfer learning therefore has the advantage that the system can be quickly adjusted to changed situations, in particular to a changed laser machining process.

The neural network may be an RNN (“recurrent neural network”), an LSTM (“long short term memory”) layer and/or at least one GRU (“gated recurring units”) layer. Thereby, the performance of the neural network can be improved.

The sensor data included in the sensor data set may be unprocessed, i.e. raw data. The sensor data may therefore be mapped using the transfer function or the trained neural network without data pre-processing. In this case, an “end-to-end” mapping is performed without previously extracting, calculating or parameterizing features from the sensor data. The trained neural network may therefore determine the value of the at least one physical property based directly on the raw data. A result neuron of the neural network may then directly output the value of the physical property.

According to a further aspect of the present invention, a system for analyzing a laser machining process is provided, said system being configured to carry out the method described above. The system includes a sensor unit configured to acquire the at least one sensor data set for the laser machining process; and an analysis unit configured to determine the value of the physical property using the transfer function formed by the trained neural network. The analysis unit may include the transfer function formed by the trained neural network.

The sensor unit may include a diode, a photodiode, an image sensor, a line sensor, a camera, a spectrometer, a multispectral sensor and/or a hyperspectral sensor.

The analysis unit may be configured to determine the value in real time and/or to output control data to a laser machining system carrying out the laser machining.

According to a further aspect of the present invention, a laser machining system for machining a workpiece using a laser beam is provided, said laser machining system comprising a laser machining head for radiating a laser beam onto a workpiece to be machined and the system for analyzing a machining result described above. The laser machining system according to embodiments of the present invention may also be referred to as a “predictive monitoring system”. The laser machining system may be a laser welding system, a laser soldering system or a laser cutting system. The laser machining system may include a control unit. The analysis unit may be integrated in the control unit.

According to the present invention, a physical quantity or property may thus be assigned quantitatively to a machining result in order to determine the quality of the machining result. Here, the physical property is assigned or quantitatively determined by an in-process and/or post-process system based on acquired sensor data sets, for example from sensed process radiation. The determination of the value of the physical property is preferably carried out while simultaneously considering a plurality of different sensor data sets or different types of process radiation. In this way, the value determination becomes more accurate and reliable. The determination of the value of the physical property of the machining result may be based on raw data from the laser machining process (so-called “end-to-end” data processing). Data pre-processing may therefore be omitted so that the method can run more quickly and easily.

### BRIEF DESCRIPTION OF THE DRAWINGS

Embodiments of the present invention are described in detail below with reference to figures.

FIG. 1 shows a schematic diagram of a laser machining system for machining workpieces using a laser beam and a system for analyzing a machining result of a laser machining process according to embodiments of the present invention;

FIG. 2 shows a method for analyzing a machining result of a laser machining process according to embodiments of the present invention; and

FIG. 3 shows a diagram of an objective function when training a neural network according to embodiments of the present invention.

### DETAILED DESCRIPTION OF THE INVENTION

Unless otherwise noted, the same reference symbols are used below for the same elements and those with the same effect.

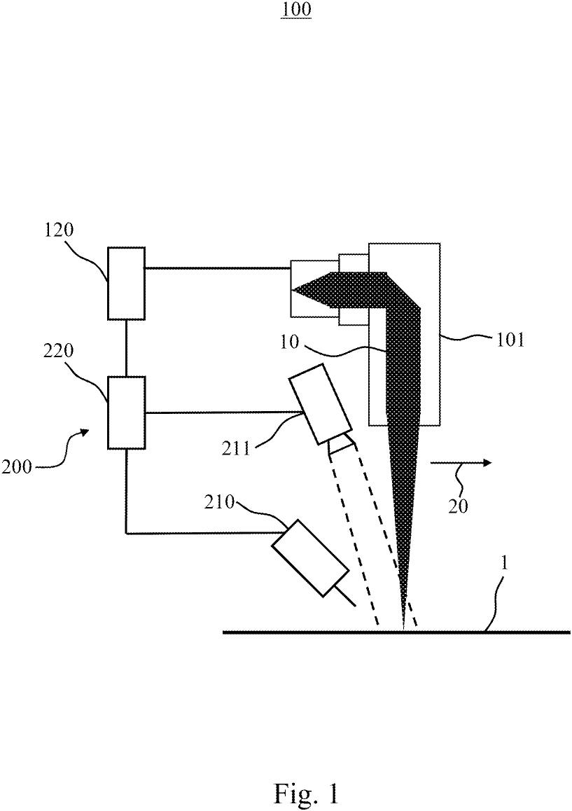

FIG. 1 shows a schematic diagram of a laser machining system 100 for machining a workpiece by means of a laser beam 10 according to embodiments of the present disclosure. The laser machining system 100 is configured to carry out a laser machining process, in particular laser welding, laser soldering or laser cutting, and the method for analyzing a machining result of the laser machining process according to embodiments of the present invention.

The laser machining system 100 includes a laser machining head 101, in particular a laser soldering, laser cutting or laser welding head, and a system 200 for analyzing a machining result of the laser machining process according to embodiments of the present invention. The laser machining system 100 further includes a control unit 120 for controlling the laser machining system 100. The laser machining head 101 is used to provide a laser beam 10 (also referred to as “machining beam” or “machining laser beam”) and may include elements for beam shaping and guidance of the laser beam 10 (not shown). When the laser machining process is carried out, the laser beam 10 is directed or radiated onto the workpiece 1. In the process, material of the workpiece 1 is melted and/or evaporated, as a result of which a vapor capillary and a melt pool surrounding the vapor capillary are formed, for example during welding or soldering. This area of interaction between the laser beam 10 and the workpiece 1 may also be referred to as the “machining area”.

According to embodiments, the laser machining system 100 or parts thereof, such as the laser machining head 101, may be movable in a machining direction 20 relative to the workpiece 1. Alternatively or additionally, the workpiece 1 may be movable relative to the laser machining system 100 or parts thereof counter to the machining direction 20. The machining direction 20 may be a cutting, welding, soldering direction and/or a direction of movement of the laser machining system 100, for example the laser machining head 101, with respect to the workpiece 1. In particular, the machining direction 20 may be a horizontal direction. The machining direction 20 may also be referred to as “feed direction”.

The system 200 for analyzing a machining result of the laser machining process includes a sensor unit 210 for acquiring a sensor data set of the laser machining process. The sensor data set includes sensor data based, for example, on a measurement of process radiation or radiation intensity of a process radiation of the laser machining process from the machining area and a radiation emitted or reflected by a surface of the workpiece. The process radiation may include thermal radiation, plasma radiation and reflected or backscattered laser radiation. For this purpose, the sensor unit 210 may comprise a diode, a photodiode, a line sensor, an image sensor, a camera, a spectrometer, a multispectral sensor and/or a hyperspectral sensor. For example, data over a specific wavelength range may be acquired in a spatially resolved manner using image sensors or not in a spatially resolved manner with diodes or with spectrometers in a frequency resolved manner. Alternatively or additionally, the sensor data set may include sensor data acquired for one or more process parameters, such as the focus position, focus diameter and/or distance of the laser machining head 101 from the workpiece 1, during the laser machining process. Correspondingly, the sensor unit 210 may include sensors for acquiring these process parameters, for example a capacitive or inductive distance sensor, an optical coherence tomography system, etc.

The system 200 for analyzing a machining result comprises an analysis unit 220. The analysis unit 220 is configured to determine a value of at least one physical property using a transfer function based on the at least one sensor data set acquired for the laser machining process carried out by the laser machining system 100. The analysis unit 220 is connected to the sensor unit 210 so that the analysis unit 220 can receive the sensor data sets acquired by the sensor unit 210.

According to an embodiment, the analysis unit 220 includes a processor for determining the value of a physical unit according to embodiments of the present invention. The transfer function is typically stored in a memory (not shown) of the analysis unit 220 or implemented as a circuit, for example as an FPGA. The transfer function is formed by a learned, i.e. pre-trained, neural network. The value of the at least one physical property is determined by applying the transfer function to the at least one sensor data set. The memory may be configured to store further data, for example the determined value. The analysis unit 220 may be connected to the control unit 120 of the laser machining system 100 in order to transmit the determined value to the control unit 120. According to an embodiment, the analysis unit 220 is combined with the control unit 120 (not shown). In other words, the functionality of the analysis unit 220 may be combined with that of the control unit 120 in a common processing unit.

The analysis unit 220 may further be configured to receive control data from the control unit 120 of the laser machining system 100 and also to use the control data for determining the value of the physical property. The control data may include, for example, the laser output power, the target distance of the machining head 101 from the surface of the workpiece 1, the feed direction and speed, each at a given point in time.

According to embodiments, the sensor unit 210 may include an image acquisition unit 211 configured to capture images of a surface of the workpiece 1 and/or of the machining area of the laser machining process and to transmit them to the analysis unit 220 as a sensor data set. According to an embodiment, the image acquisition unit 211 is arranged on or attached to the machining head 101. For example, the image acquisition unit 211 may be arranged downstream of the machining head 101 with respect to the machining direction 20. The image acquisition unit 211 may be oriented coaxially or at an angle to the laser beam 10. The image acquisition unit 211 may comprise a camera system or a stereo camera system, e.g. with reflected light LED lighting. According to the invention, the images correspond to a two-dimensional image of a section of the workpiece surface. In other words, the captured images represent a two-dimensional image of the workpiece surface. The images may be captured at a predetermined rate over a predetermined period of time.

The control unit 120 may further be configured to control the machining head 101 and/or the sensor unit 210 and/or the image acquisition unit 211.

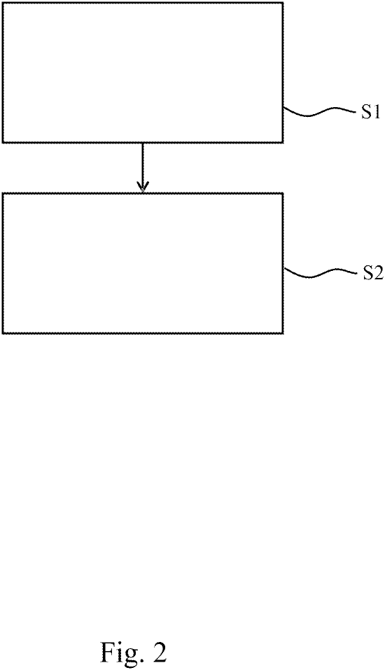

FIG. 2 shows a method for analyzing a machining result of a laser machining process according to embodiments of the present invention. The method comprises the steps of: acquiring at least one sensor data set for the laser machining process (S1); and determining a value of at least one physical property of a machining result of the laser machining process based on the at least one sensor data set using a transfer function (S2), the transfer function being formed by a trained neural network. The laser machining system 100 described above with reference to FIG. 1 or the system 200 described above for analyzing a machining result are configured to carry out the method shown in FIG. 2.

According to embodiments, the at least one sensor data set includes measurement values of a radiation intensity of the thermal radiation emitted from the machining area of the laser machining process. According to other embodiments, further sensor data sets may be acquired and used to determine the value of the physical property. For example, the sensor data sets may include measurement values of a radiation intensity at different wavelengths, for example an intensity of emitted plasma radiation and/or of reflected laser radiation, also called “back-reflected radiation”. Furthermore, the sensor data sets may also include images of the machining area of the laser machining process. All of these sensor data sets may represent input data sets for the neural network. In addition, process-relevant input variables or control data, such as a predetermined laser power, a predetermined machining speed, a workpiece material and/or a workpiece thickness, may also be used as input data sets for the neural network.

According to embodiments of the present invention, the physical property under consideration, the value of which is determined or predicted by the method according to the invention, is the strength, in particular the tensile strength, of a welded joint between two workpieces joined by a laser welding process.

In order to determine a value of the strength, the aforementioned data are acquired or recorded at a predetermined sampling rate over a predetermined period of time, for example for the duration of the laser welding process. The size of the sensor data set therefore depends on the sampling rate and the duration of the laser welding process and thus also on the length of the weld seam to be produced by the laser welding process. The sensor data set acquired in this way is also called “time data series” or “time series” and may form an input vector or tensor of the neural network. When the process radiation is measured at different wavelengths or in different wavelength ranges, the correspondingly acquired sensor data sets may be combined into a multi-dimensional tensor. When images or image data are additionally acquired and added to the sensor data sets, a higher-dimensional tensor is created.

In order to teach the neural network, also called “training”, before the system according to the invention is put into operation or before the method according to the invention is carried out, exemplary training data sets are created for the neural network. For this purpose, a large number of machining processes, e.g. weldings, are carried out and the associated physical properties of the respective machining result are measured experimentally. For example, the intensities of a thermal radiation, a reflected laser radiation and/or a plasma radiation are measured during a laser machining process and acquired in at least one sensor data set for each welding. The at least one physical property of the machining result is then measured. The physical property of the machining result is preferably determined in a reference measurement system, for example in a conventional system for determining the tensile force or tensile strength. The corresponding measurement value of the physical property is assigned to each sensor data set in the training data sets.

In an example of quantifying the tensile strength, the intensities of the emitted process radiation, i.e. temperature radiation, back-reflected laser radiation and plasma radiation, are acquired for a large number of welding processes over a welding period of 0.5 s and at a sampling rate of 50 KHz, and a tensor of the dimensions 3 × 25000 is formed therefrom. Furthermore, the value of the tensile force at which the formed weld breaks is measured for each welding process. The measurement is carried out with a reference measurement system, for example. The tensile force at which the weld breaks is defined as the tensile strength of the weld. These tensile force values, typically in Newton, are assigned to the respective tensors in order to generate training data sets. The neural network, which is in particular configured as a deep neural network, for example with an architecture made up of convolutional layers, LSTM layers and/or fully connected layers, is then trained with this training data in order to later predict a value for the tensile strength of weld seams produced using this welding process.

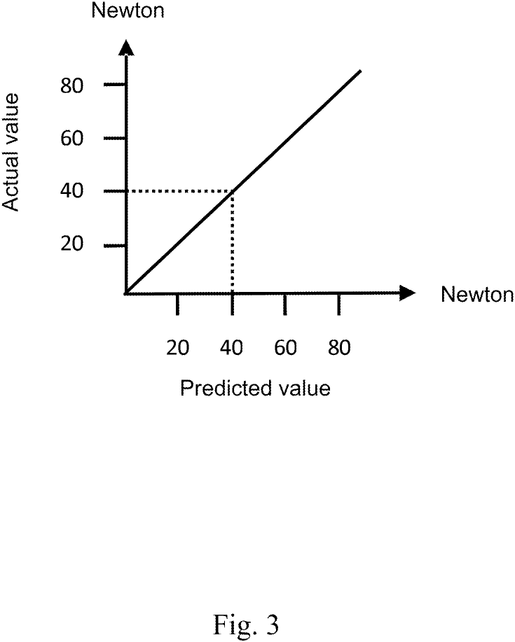

When training the neural network, the sensor data sets or the time series are mapped to the physical property, for example the tensile strength. The objective function, also known as the “cost function”, is minimized using an optimization process such as backpropagation. After optimization of the objective function to zero, an assignment of a predicted or estimated value of the physical property, for example the tensile strength, to the actually measured value would form a straight line, as shown in FIG. 3. Each predicted or estimated value for the tensile force corresponds to the actual measured value. However, since such measurements are always subject to error, the curve shown in FIG. 3 is highly idealized.

After completing the training with a given variable of the objective function, a model containing the neural network and the parameters of the neural network is obtained. This model may be the transfer function according to embodiments of the present invention. During inference, i.e. when carrying out the method according to the invention, the acquired sensor data sets are mapped to a regression value or to a value of the physical property by the transfer function. The inference thus provides the predicted physical property directly, in the case described the tensile force at which the weld seam will break. This procedure may be carried out for all physical properties that can be determined by measuring the weld seam produced by the laser welding process. The only prerequisite for this is that the information about the measurement value to be predicted for the respective physical property is contained in the signals from the process.

Although the present invention has been illustrated above using examples of a welding process, the present invention is not limited thereto. The laser machining process may also be a laser cutting process or a laser soldering process. In order to assess the laser cutting process, corresponding physical properties, such as the roughness of a cut edge of a workpiece cut by the laser machining process, a burr or a burr height of a cut edge of a workpiece cut by the laser machining process, a steepness of the cutting front and a perpendicularity of a cut edge of a workpiece cut by the laser machining process may also be quantified according to the present invention to analyze the laser cutting process.

A user of the laser machining system according to embodiments of the present disclosure does not need to set any parameters. The basic training of the neural network is carried out before the system for analyzing the laser machining process is put into operation, using training data that contain the example data previously collected in the field and the values of the physical property of the machining result under consideration assigned thereto. In the case of minor changes to the laser machining process, transfer learning of the trained neural network may be carried out.

According to the invention, a regression of the at least one acquired sensor data set to a numerical value for the at least one physical property may thus be carried out by the trained neural network. The sensor data sets may form a multi-dimensional vector, typically consisting of time series data such as temperature radiation, plasma radiation and/or reflected laser radiation, and directly form an input tensor of the trained neural network. Therefore, an “end-to-end” mapping is preferably performed without previously extracting, calculating or parameterizing features. By considering or combining the input data in different ways, various physical quantities or properties can then be quantified by the transfer function, i.e. by the trained neural network. The trained neural network then directly outputs the regression result, i.e. the value of the physical property.

By mapping one or more sensor data sets to a value of at least one physical property and the resulting finely granular evaluation metrics, laser machining processes can be better analyzed and adjusted to material or environmental fluctuations. The present invention allows for knowledge to be accumulated on the basis of data aggregated during the production life cycle of a laser machining system and can thus provide an ever more accurate basis for decision-making over the course of a service life.

### LIST OF REFERENCE SYMBOLS

Workpiece 1
Laser beam 10
Machining direction 20
Laser machining system 100
Laser machining head 101
Control unit 120
System for analyzing a machining result 200
Sensor unit 210
Image acquisition unit 211
Analysis unit 220

1. A method for analyzing a laser machining process, said method comprising the steps of:
acquiring at least one sensor data set for the laser machining process; and
determining a value of at least one physical property of a machining result of the laser machining process based on the at least one sensor data set using a transfer function,
said transfer function being formed by a trained neural network.

2. The method according to claim 1, wherein acquiring at least one sensor data set is based on a measurement of process radiation of the laser machining process and/or on a measurement of at least one process parameter of the laser machining process.

3. The method according to claim 2, wherein the at least one process parameter comprises a keyhole depth, a focus position, a focus diameter and/or a distance of a laser machining head carrying out the laser machining process from a workpiece.

4. The method according to claim 1, wherein the at least one sensor data set is based on a measurement of a radiation intensity of process radiation of the laser machining process and/or on an image of a machined surface of a workpiece.

5. The method according to claim 4, wherein the radiation intensity is measured for a predetermined period of time and/or in at least one predetermined wavelength range and/or at at least one predetermined wavelength and/or in a spatially resolved manner and/or in a frequency-resolved manner.

6. The method according to claim 2, wherein the process radiation of the laser machining process comprises at least one of temperature radiation, plasma radiation, and laser radiation reflected from a surface of a workpiece.

7. The method according to claim 1, wherein the value of the at least one physical property is determined based on at least two sensor data sets that have been acquired by different sensors for the same period of time.

8. The method according to claim 1, wherein the physical property of the machining result is selected from a group comprising a tensile strength, a compressive strength, an electrical conductivity, a keyhole depth, a welding depth, a gap size of a gap between two workpieces joined by the laser machining process, a roughness of a cut edge of a workpiece cut by the laser machining process, a burr of a cut edge of a workpiece cut by the laser machining process, a burr height of a cut edge of a workpiece cut by the laser machining process, a steepness of the cutting front and a perpendicularity of a cut edge of a workpiece cut by the laser machining process.

9. The method according to claim 1, wherein the at least one sensor data set is acquired during and/or after the execution of the laser machining process, and/or
wherein the value of the physical property is determined while the laser machining process is performed and/or after the laser machining process has been completed.

10. The method according to claim 1, wherein the value of the physical property is further determined based on at least one control data set of the laser machining process.

11. The method according to claim 9, wherein the at least one control data set comprises control data for a laser power, a distance between a laser machining head carrying out the laser machining process and the workpiece, a focus position, a focus diameter, a path signal, a workpiece material and/or a workpiece thickness.

12. A system for analyzing a laser machining process, wherein said system is configured to carry out the method according to claim 1, said system comprising:
a sensor unit configured to acquire the at least one sensor data set for the laser machining process; and
an analysis unit configured to determine the value of the at least one physical property by means of the transfer function formed by the trained neural network.

13. The system according to claim 12, wherein said sensor unit comprises a diode, a photodiode, an image sensor, a line sensor, a camera, a spectral sensor, a multispectral sensor and/or a hyperspectral sensor.

14. The system according to claim 12, wherein said analysis unit is configured to determine the value of the at least one physical property in real time and to output control data to a laser machining system carrying out the laser machining process.

15. A laser machining system for machining a workpiece by means of a laser beam, said laser machining system comprising:
a laser machining head for radiating a laser beam onto a workpiece to be machined; and
a system according to claim 12.
